(19) United States
(12) Patent Application Publication
(10) Pub. No.: US 2014/0114793 A1
(43) Pub. Date: Apr. 24, 2014

(54) Method for Content-Customization of Products and Services

(71) Applicant: Robert Silver, Madison, NJ (US)

(72) Inventor: Robert Silver, Madison, NJ (US)

(21) Appl. No.: 14/058,811

(22) Filed: Oct. 21, 2013

Related U.S. Application Data
(60) Provisional application No. 61/717,247, filed on Oct. 23, 2012.

(51) Int. Cl. G06Q 30/06

(52) U.S. Cl. CPC G06Q 30/0621
USPC 705/26.5

(57) ABSTRACT

A method is provided by which one or more vendors utilize text messaging to collect or identify customization content from one or more purchasers and/or content contributors, so that the vendors can incorporate or associate the customization content into one or more products or services customized by the purchasers and/or content contributors. According to this method, vendors utilize or provide one or more software components executed on one or more servers, computer systems or devices, or available as a remotely accessible service, to enable purchasers and/or content contributors to submit, select, and/or identify content for the customization of the products or services via text messages sent from text-message-enabled computers, servers or devices.

### REFERENCE TO RELATED APPLICATIONS

This application claims the benefit of the filing date of Provisional Application No. 61/717,247, filed Oct. 23, 2012.

### BACKGROUND OF THE INVENTION

The present invention relates to the field of business methods utilizing text messaging as a component of order processing and/or customization. More particularly, the present invention relates to methods for customizing products and services by exchange of text messages between one or more vendors and one or more purchasers and/or content contributors.

Many products and services involve customization through incorporation of textual and/or audio/visual content either in the product/service itself or an accompanying communication. For example, certain personal items, such as necklaces, bracelets, id tags, picture frames, coffee cups, and key tabs, are commonly customized by printing or engraving personal information on the item. Gifts, such as flowers, candy and fruit baskets are usually accompanied by a card containing a customized personal message. Clothing items, such as t-shirts, may be customized by printing a photograph on the item.

When such content-customized products and services are ordered via the internet, the specification of the customized content can readily be included in the on-line ordering process itself when the content to be incorporated into the customized product or service already exists on the same device which the buyer is utilizing to browse the vendor's website and customize and/or purchase the desired product or service. For off-line ordering methods, such as mail-order or phone purchases, or in scenarios in which the customized content exists on a secondary device, the collection of the customized content is often problematic.

For example, an operator taking phone orders for a content-customized product that incorporates text is apt to misapprehend or misspell words, omit portions of the message, and/or enter line breaks inappropriately. Even an automated voice-to-text transcription service is apt to introduce errors into the message resulting from inaccurate voice recognition. Such errors result in waste of product in which the content-customization is flawed. Additionally, content accepted through other means, such as photographs accepted by email, may have to be manually correlated with the content-customized products or services ordered by the purchaser. And finally, when the content that the buyer wishes to incorporate exists on a secondary device, such as a photograph that resides on a mobile phone, the fact that the content is not readily available on the primary device which the buyer is using to customize the product or service may create an impediment to a sale. For instance, if a buyer is purchasing a customized t-shirt featuring a photograph which she provides, and the buyer is customizing the t-shirt on the vendor's website from a desktop computer but the photo that the buyer wants to incorporate resides on her mobile phone, then the buyer may have to find the desired photo on the phone and transfer it to the desktop computer so that she can upload it to the vendor's website to complete the customization process.

What is needed is a method of content submission that facilitates and complements on-line and off-line communications between one or more purchasers and/or content contributors and one or more vendors of a content-customized product or service. The present invention fulfills this need by providing a customization method based on text messages exchanged between one or more purchasers and/or content contributors and one or more vendors.

### SUMMARY OF THE INVENTION

As used in this application, the terms have the meanings defined below:

Content: textual, audio, photographic, video and/or visual data.
Customization content: textual, audio, photographic, video and/or visual data, or a modified or derivative form of such data, for the purpose of customizing a product or service.
Shared short code: a standard short code combined with a phrase that a sender must include in a text message that identifies the specific recipient of the message since the short code is shared by multiple persons or entities.
Text message: a message containing electronic data, which can include textual, audio, photographic, video and/or visual content, comprised of one or more electronic communications containing such data and/or information about the message such as the telephone number, short code, or shared short code from which the message originated which are sent, transmitted, routed or delivered to one or more recipients identified by one or more telephone numbers, short codes, or shared short codes, via one or more messaging systems such as Short Message Service (SMS), Multimedia Message Service (MMS), Concatenated Short Message Service (CSMS), or a proprietary messaging service, such as Apple's iMessage™ service, that support sending, transmitting, routing or delivering such communications to at least one recipient identified by a telephone number, short code, or shared short code, where such communications are sent from one or more devices or computer systems, or telecommunications equipment, capable of interoperating with such messaging systems or by a third party capable of interoperating with such messaging systems on behalf of others, across one or more local, internet or telephone networks and received by one or more recipients, if possible, through one or more devices or computer systems, or telecommunications equipment, capable of receiving such communications via one or more such messaging systems at the telephone numbers, short codes or shared short codes specified, or by a third party service capable of receiving such communications via one or more such messaging systems at the specified telephone numbers, short codes or shared short codes on behalf of one or more recipients for whom the message is intended, to whom the third party forwards or makes available for retrieval, electronically or otherwise, the communications and/or the message, including in whole or in part the data and content contained therein, and/or information about the message, such as the telephone number, short code, or shared short code from which the message originated.
Customizable product or service: a product or service, or one or more components thereof, which incorporates, or will incorporate, customization content provided by one or more buyers and/or content contributors.
To customize a product or service: to select a customizable product or service into which buyer-provided or content-contributor-provided content or customization content is or may be incorporated, combined with at least one of the following: to select, submit, specify, identify or choose content or customization content which is, or will be, incorporated into such product or service; to select, choose, specify or designate one or more attributes, characteristics or options with respect to such product or service which affect(s) or will affect the placement, appearance, construction, composition, layout or formatting of content or customization content, or data contained therein, which is, or will be, incorporated into such product or service; to specify, directly or indirectly, the manner in or method by which content or customization content is or will be incorporated into such product or service.
Purchaser or Buyer: a person or entity, and/or the designees, employees and/or agents of such person or entity, which customizes one or more products or services, or orders or requests one or more products or services which have already been or will be customized by one or more buyers and/or one or more content contributors, regardless of whether a monetary or other consideration is involved.
Vendor or Seller: a person or entity, and/or the designees, employees and/or agents of such person or entity, which receives orders for or provides customized products or services, or components thereof, regardless of whether a monetary or other consideration is involved.
Content contributor: a person or entity, and/or the designees, employees and/or agents of such person or entity, which provides content that is used to customize a product or service but which need not be a purchaser of the customized product or service.
Primary device: a computer, server or device, which is optionally text-message-enabled, from which a buyer or content contributor initiates, participates in, and/or completes the customization of a product or service.
Secondary device: a text-message-enabled computer, server, camera, audio recorder, video recorder, or device which participates in and/or completes the customization of a product or service in concert with one or more primary devices and which contains content to be incorporated into a product or service, wherein the content can be selected, submitted, specified, identified, selected or made available from such device via one or more text messages sent from or by or received from or by the device.
Vendor Website or Site: a website, server, device, software, or application with which purchasers and/or content contributors may interact to customize customizable products and/or services.
Where “one or more” of a person, entity and/or thing is described, the use of the plural noun will designate both singular and plural. For example, when “one or more purchasers” are described, the ensuing use of the plural “purchasers” will designate a single purchaser and/or multiple purchasers.
Where software or software components are described as being executed on a computer, website, server or device, the description includes scenarios in which some or all of the software or software components are executed on one or more other computers, servers or devices with which the computer, server or device interacts.
Where text messages are exchanged between one or more software components and purchasers and/or content contributors, the participation of the purchasers and/or content contributors in such exchange may result from: one or more text messages sent as a result of human interaction with one or more text-message-enabled computers, servers or devices; or one or more text messages sent on behalf of such purchasers and/or content contributors by one or more software components executed on the text-message-enabled computers, servers or devices used by the purchasers and/or content contributors.

The present invention is a method by which one or more vendors collect one or more text messages from one or more purchasers and/or content contributors so that the vendors can incorporate and/or associate the content contained in and/or referenced in such message(s) into or with one or more products or services ordered by the purchasers and/or content contributors or made available by the vendors for customization by one or more purchasers and/or content contributors. In this method, vendors utilize one or more software components executed on one or more servers, computer systems or devices, or available to them as a remotely accessible service, to enable purchasers and/or content contributors to submit, select and/or identify content for the customization of the vendor's products and/or services via text messages sent from text-message-enabled devices.

Purchasers and/or content contributors who possess text-message-enabled devices can remotely communicate with the software to transmit content and/or content identifiers to vendors via text message. In an automatic or semi-automatic fashion, such software, executed on one or more primary or secondary devices, or remotely accessible computer systems, servers, or devices, can receive and send text messages to collect and/or identify the content that purchasers wish to incorporate in a customized product or service. Additionally, the software may act on behalf of a single vendor or multiple vendors concurrently, and may be implemented as a hosted service or application, in which one or more vendors and purchasers and/or content contributors may utilize it simultaneously over one or more local, internet or telephone networks.

The software can send text messages to and receive text messages from purchasers and/or content contributors, or from purchasers and/or content contributors to vendors, by utilizing remotely accessible telecommunications equipment or text-message-enabled devices, by utilizing telecommunications equipment or text-message-enabled devices incorporated into or attached to the server(s), computer system(s) or device(s) on which the software operates or the computer network(s) to which such server(s), computer system(s) or device(s) are connected, or by utilizing available telephony-to-internet software or services which, when employed, can enable internet-connected devices, computer systems or servers to send and receive text messages. By exchanging one or more text messages, the software and purchasers and/or content contributors engage in a “conversation” in which the software obtains, and the purchasers and/or content contributors submit, select and/or identify, any information or content necessary to the production of the customized products or fulfillment of the customized services ordered by the purchasers or made available by the vendors for purchase or customization.

The “conversation” engaged in by the purchasers and/or content contributors and software will vary according to the particulars of the company, the products and/or services being customized, the type of content that the vendor is requesting, and the method of order-taking. For instance, the questions that a vendor must instruct the software to ask, and the responses to expect, will vary significantly if a purchaser is submitting customized lines of text to be engraved on a metal ID tag versus submitting or selecting a photograph to be printed on a t-shirt. In some instances, the “conversation” may only consist of a single, inbound text message from a purchaser and/or content contributor, if a single inbound text message provides sufficient information for a vendor to produce and/or make available for purchase or customization a customized product or service.

A vendor will also decide as to whether the purchaser has to initiate contact with the software, or whether the software is instructed to initiate contact with the purchaser. In the first case, for instance, a vendor can elect to have purchasers and/or content contributors proactively send a text message to a specific phone number to initiate a conversation with the software. In the latter case, a vendor could, for instance, send a text message soliciting the purchaser's content while the purchaser is on the telephone with an operator. In more complex implementations of the software, a vendor may also choose to employ both methods of initiating contact: for instance, some products or services may require the purchasers and/or content contributors to initiate contact with the software, while other products or services may require an agent of the vendor to instruct the software to contact the purchasers and/or content contributors. Additionally, the software may be programmed to automatically contact buyers and/or content contributors via text message or request that the buyers and/or content contributors contact the software via text message (for example, by displaying a message on a website) to solicit the collection of content, under certain circumstances, such as the buyer reaching a point in the on-line customization process on a vendor's website which necessitates the collection of content.

The manner in which the software collects information and content from purchasers and/or content contributors will also differ according to the vendor's requirements and business model. For instance, a vendor may decide to implement software which collects content from purchasers and/or content contributors in a fully automatic fashion with no intervention necessary on the part of the vendor. Or, a vendor may find it more advantageous to have a semi-automatic system manned by an operator who can view incoming text messages in near-real time and make decisions based upon those inputs, such as whether to ask a purchaser and/or content contributor who is submitting customized text to the software for clarification on a misspelling, or to manually tailor outgoing responses. Additionally, a vendor may find it useful or necessary for the software to be designed such that it queries the vendor for content to send to the purchasers and/or content contributors. In certain circumstances, the software may engage in the same text message “conversation” that it has with the purchasers and/or content contributors with the vendor itself, for instance to collect from the vendor via text message a photograph or a simulation of the purchasers' and/or content contributors' finished, customized product(s) which the software will then automatically route back to the purchaser(s) and/or content contributor(s) via text message. By allowing the vendor to interact with the software in the same manner as a purchaser and/or content contributor would, the software can act as a go-between between the vendor and the purchaser and/or content contributor more efficiently in certain scenarios than if, for instance, the vendor had to take photos of all the finished products, return to a computer, upload them, find each individual purchaser's and/or content contributor's email address and send the photos. Additionally, the software may be able to construct such a preview in an automatic, programmatic fashion which it may return to the purchasers and/or content contributors for review, without assistance from an agent of the vendor.

Additionally, the method by which collected information or content is made available to vendors, or the manner in which the software is used in connection with or incorporated into other automated devices or systems, will change according to the vendor's various requirements, including but not limited to the type of content received, product ordered or service requested, ordering processes, method and manner of production or fulfillment, and the requirements imposed on the vendor by third parties to whom the vendor may need to transmit such content.

For instance, in some scenarios, it may be useful to the vendor if all of the collected information and content were aggregated and archived in a web interface which employees could access. This web interface could then use and transform the received content to provide other useful business functions, for instance, by converting all text submissions into PDF files ready for print. In other scenarios, however, the vendor might elect to simply instruct the software to email any received content to a specific email address, or to sort and send content to a variety of email addresses based on its type, so that photographs are sent to one email address and text submissions to another (for instance, a manufacturer's email address). Or, programmatic access could be granted to the content so that the vendor could automate the process of providing the content to third parties.

In other scenarios, a vendor may wish to utilize the software with, extend it to include, or incorporate it into another automated device or system so that the collected content can be utilized or transformed into a completed product or service more directly, rather than just being provided to the vendor. For instance, a vendor may want to utilize the software of the present invention with other automated devices such as a printer or laser-marking machine so that these devices receive instructions from the software. By utilizing such devices with the software of the present invention, a vendor could, for example, create an implementation of the software in which a purchaser could send a single inbound text message causing, without human intervention, a printer to immediately print a photograph or a laser-marking machine to immediately laser-mark text onto a product that has been pre-loaded into the machine.

In such circumstances, there are numerous methods through which the software can be extended or utilized to achieve this goal: the software could be incorporated into the automated device itself; the software could be extended to interact with a locally or remotely accessible device without being incorporated into the device, such that the device becomes incorporated into the software; or the content could be made programmatically available, for instance through an Application Programming Interface (API) or remotely accessible web service, such that the vendor could create an intermediary system which would programmatically contact the software of the present invention to retrieve the necessary content and subsequently control the device attached to the intermediary system.

In cases where a purchaser is purchasing a product or service from a vendor which the purchaser customizes, the method of the present invention can be used to customize a product or service before purchase or after purchase via an identifier which identifies the customization content submitted or selected by a buyer. In the pre-purchase scenario, the buyer text messages his or her customization content prior to purchase then submits the customization content identifier as part of the transaction. The identifier can be complex, like a serial number, or simple, such as the buyer's phone number, where the software keeps track of the phone numbers from which it receives content and the buyer submits his or her phone number at the time of purchase, linking the purchase to the content. The collection of identifiers can occur in an individual transaction between a buyer and a vendor, or between many buyers (or an intermediary buyer who aggregates the transactions) and the vendor(s).

An example of the pre-purchase scenario is a school which sells metal ID tags via paper order forms that go home to the families of students in the school. Families receive these order forms, text message their custom message to be engraved on the tags, and write down a resulting “confirmation code” on the paper order form, then hand in that order form with payment made to the school. The school aggregates all of the orders and submits their single order to the vendor along with the confirmation code identifiers that allow the vendor to call up the content from each individual order for production.

In the post-purchase scenario, an identifier is pre-generated for a customizable product or service. This identifier may be the buyer's phone number, or a more complex identifier such as a serial number. This identifier then allows a buyer to customize a product or service after having already purchased it by having the text message system either prompt the customer for such an identifier or automatically infer it, for instance from a telephone number from which the user is texting content.

An example of the post-purchase scenario is the retail sale of metal ID tags, where the vendor supplies the tags to a retailer who sells blank tags that are customizable post-purchase. A buyer purchases a tag from the retail establishment, text messages a provided phone number, and the text messaging software requests the pre-generated serial number that provides proof that the buyer actually purchased the tag and qualifies to receive a customized, replacement tag. The buyer sends the vendor his/her custom message for engraving via text message, and the vendor engraves and mails back to the buyer a customized metal tag. Other delivery options are available, such as the vendor sending the customized tag to the retail establishment (the intermediary) for pickup by the purchaser.

The transaction can also occur concurrently with the purchase where the buyer simply text messages the provided telephone number and provides his or her phone number or another identifier to the vendor at the time of purchase, or one or more agents of the vendor simply looks at the list of incoming customization content and match up the content to the buyer.

In all three scenarios, the vendor may sell a customized product or service without providing the actual product at the time of purchase, such as by simply taking money and providing instructions on how to submit the content for customization of the final product or service, which may ship or be provided either from or by one or more vendors and/or one or more third-party manufacturers or providers. Consequently, such post-purchase scenarios may result in the sale of products or services which are partially complete. Subsequent to purchase, one or more customized components may be provided in addition to, or as a replacement for, one or more components which were included in the product or service which was initially provided.

Additionally, it should be noted that in some embodiments of the present invention, the person or entity, and/or designees, employees and/or agents of such person or entity, which contribute(s) content with which a product or service is customized may not be the same individual or entity, and/or designees, employees and/or agents of such person or entity, who purchase(s) the customized product or service. In some scenarios, the software of the present invention may collect content via text message from one or more content contributors, wherein such collected content is then incorporated into one or more products or services or components thereof which are then made available for purchase or customization by one or more purchasers and/or content contributors. The use of identifiers, as explained above, would also be applicable to such scenarios where a vendor might find it advantageous to control the point at which one or more content contributors provide content for a product or service which the vendor makes, or will make, available for purchase or customization.

In some embodiments of the present invention, a preview of the product is provided by the vendor or the software, in cases where such preview may be programmatically generated, to the purchasers and/or content contributors, which preview can be either simulated or actual. In the simulated scenario, the submitted or selected customization content is electronically combined with a preview of the product or a component of the product and sent back as a rendering or representation of the finished product. For instance, a buyer texts an audio recording to be incorporated into a greeting card that can play sound, and the system texts back an image of the greeting card and a link to the collected audio file, so that the buyer has a preview of which two items (the card and the audio file) will be produced. In the actual scenario, the vendor (and/or the vendor's contractors, manufacturers, etc.) may produce the product or service and send back to the buyer a preview of the actual customized product or service.

In some embodiments of the present invention, the content that is submitted, selected or identified by the purchasers and/or content contributors may be modified, and the modified version of the content may be used to create the final product or service. For instance, a buyer submits a color photo, and the software or a human turns it into a black-and-white image prior to insertion into the finished product. Or, the buyer submits a photo to a t-shirt company whose specialty is creating witty captions, and the company takes the photo, combines it with a caption, and prints both on the t-shirt. In other embodiments, multiple buyers and/or content contributors submit customization content for incorporation into a customized product or service; for example, a printed photo collage in which images are collected from multiple students in a school. Products or services which incorporate customization content may be sold or provided to buyers who did not submit content, or to content contributors who have not purchased the product and/or service. In the photo collage example, the students who submit photos for incorporation into the photo collage may not necessarily purchase the collage, but other students may purchase it.

In some embodiments of the present invention, the incorporation of submitted content into the customized product or service may be delayed. For instance, an online marketplace that allows photographers to sell photo prints may collect the photographs that the photographers wish to sell via text message for incorporation into customized photo prints that are then sold to other customers. It would not make sense to immediately produce a customized item based on this content, but the collection of the photographs is specifically for the purpose of producing photo prints which incorporate them and which will be manufactured at a later date when purchased by one or more buyers. The photographs are also being provided via text message by the photographer who is unlikely to order the prints himself.

Another scenario in which the invention may be used to customize a product or service is one in which a purchaser customizes the product or service from one or more primary devices while the content to be incorporated into such product or service exists on one or more secondary devices. The software component(s) of the present invention may be used to collect the content to be incorporated from the secondary device(s) to make it available to the purchaser in the customization process which is occurring on the primary device(s). In such a scenario, the content that is solicited from the purchaser may be made directly available (for instance, through automatic download) to the purchaser's primary device(s), or indirectly available, for instance by making the content available in the vendor's website which the purchaser is already browsing via the primary device(s).

An example for using the invention in this manner is a scenario in which a purchaser wishes to customize a product or service via a website that she is viewing from a desktop computer (a primary device), but the content that she wishes to incorporate into such a product exists on a secondary device, such as a photograph contained on a mobile phone. In such a scenario, the software of the present invention may solicit from the purchaser the content on the mobile phone via text message, which the vendor's systems may then make available to the purchaser via the website that she is currently browsing on her computer. Submission of the content to be incorporated in such a manner is advantageous because it does not require the purchaser to transfer the content she wishes to incorporate into the product from the phone to the computer to submit it to the vendor.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic flow-chart of the first embodiment of the present invention.

FIG. 2 is a schematic flow-chart of the second embodiment of the present invention.

FIG. 3 is a schematic flow-chart of the third embodiment of the present invention.

FIG. 4 is a schematic flow-chart of the fourth embodiment of the present invention.

FIG. 5 is a schematic flow-chart of the fifth embodiment of the present invention.

FIG. 6 is a schematic flow-chart of the sixth embodiment of the present invention.

### DETAILED DESCRIPTION OF THE PREFERRED EMBODIMENTS

### First Embodiment

### Laser-Etched Metal ID Tags Ordered by Telephone

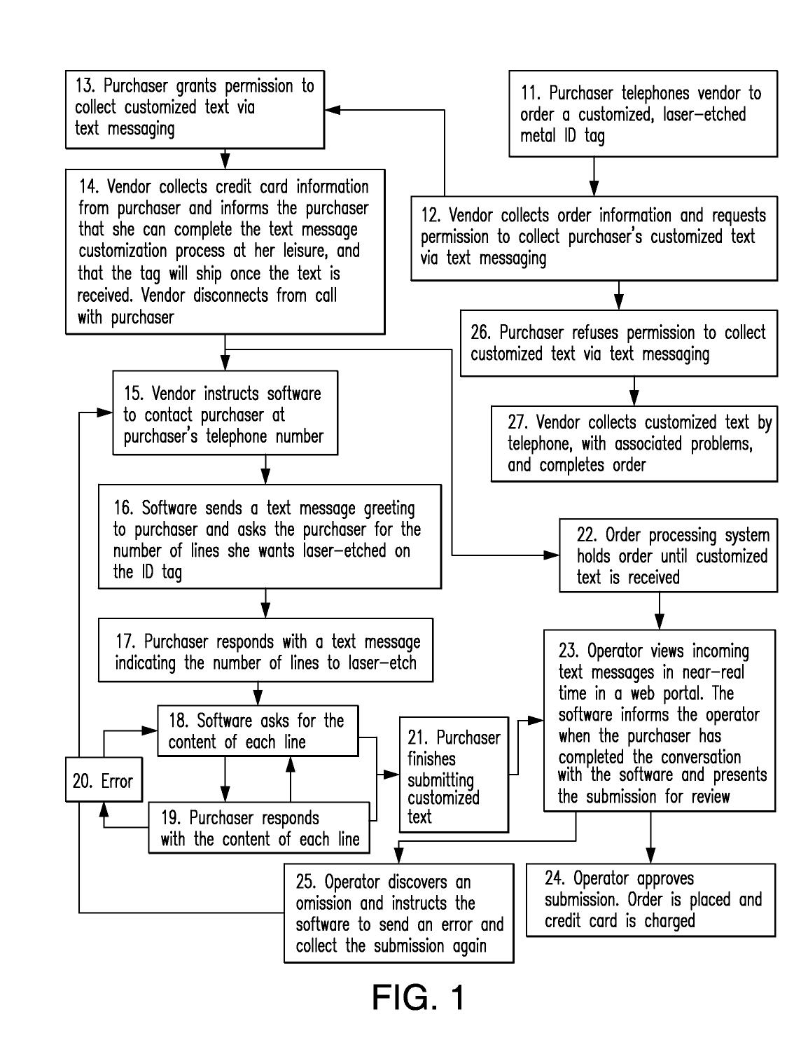

In the following example, illustrated in FIG. 1, a purchaser wishes to order, over the telephone, a metal ID tag featuring customized, laser-etched text. To begin, the purchaser calls the vendor to place an order for the metal ID tag over the telephone 11. Upon receiving the purchaser's call, and inquiring into the items the purchaser wishes to order 12, the vendor realizes that the purchaser wishes to order an item that supports custom laser-etching.

Consequently, rather than keeping the purchaser on the phone, the vendor informs the purchaser that the vendor can take the purchaser's payment information and send her a text message that will enable her to engage in a “conversation” 16-21 with the software which will result in allowing her to submit her customized text for laser-etching via text message, even after the vendor hangs up 14.

Short on time to stay on the phone, the purchaser agrees. Having already collected the purchaser's payment information, the vendor disconnects from the telephone call with the purchaser and instructs the software to contact the purchaser 15 at the same telephone number from which the purchaser called the vendor. Meanwhile, the order is placed on hold and will not be charged to the customer's credit card or shipped until the purchaser has submitted her customized text 22.

Subsequently, the software engages in a “conversation” with the purchaser, sending a greeting and asking how many lines of customized text she would like laser-etched on her ID tag 16. The purchaser replies with the number of lines 17, and then she and the software engage in a back-and-forth exchange in which she submits the customized text for each line 18-19. The purchaser finishes submitting her customized text at her convenience 21.

Meanwhile, the vendor occasionally checks a web portal made available by the software which shows the vendor which purchasers are currently interfacing with the software, text messages sent, text messages received, and which conversations are complete. The vendor notices that the web portal has flagged a submission from the purchaser 23 who is identified as the same purchaser from the vendor's telephone conversation based upon the telephone number of the incoming text messages received by the software. Reviewing the purchaser's submission and noticing it is free of any errors or omissions, the vendor approves the order 24.

### Second Embodiment

### Customized T-Shirts by Mail Order

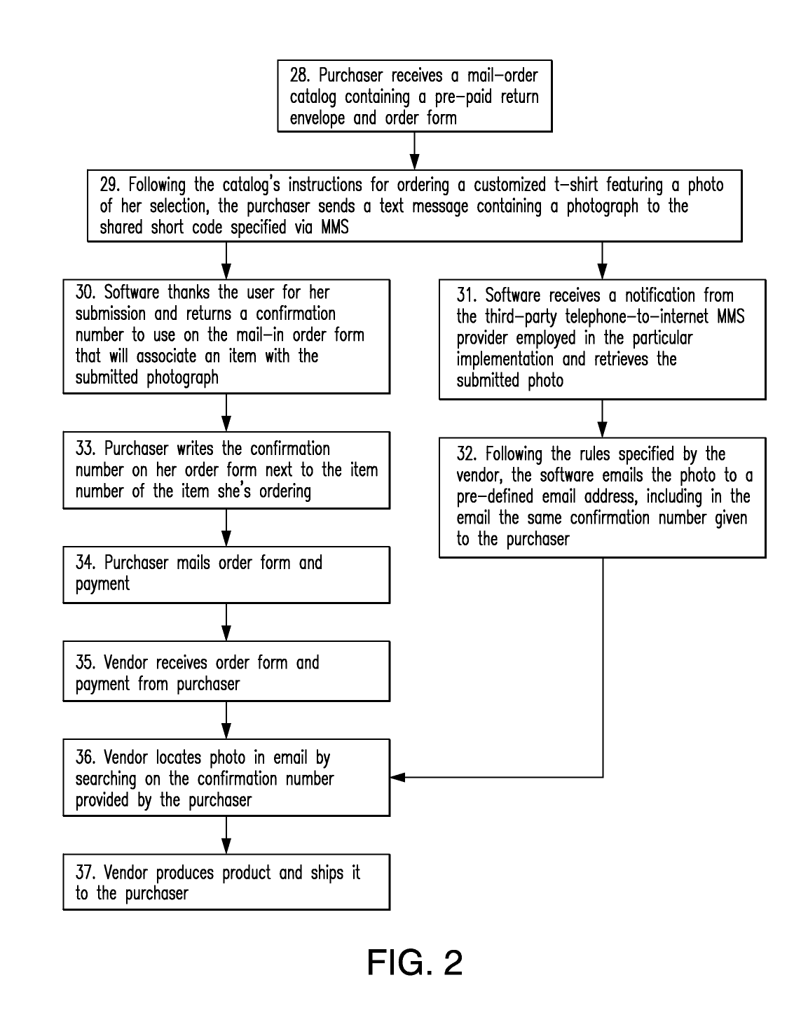

In this example, illustrated in FIG. 2, a purchaser receives a mail-order catalog from a vendor 28 offering customizable t-shirts for sale which feature a printed photograph of the purchaser's choosing. The vendor requires that the photograph be delivered as a digital file (for instance, in the JPEG image file format). The vendor, having gone through the trouble of printing and sending a physical catalog, and not wanting to impede a potential sale, has included within the catalog a pre-paid return envelope and order form which the purchaser may use to order from the vendor. The problem: the vendor has provided a manual paper-based ordering system but requires a digital photo to print on the purchaser's t-shirt.

Not having ready access to her standalone digital camera or computer, the purchaser notices that the vendor's catalog advertises that she can submit a digital photo from her phone with ease by simply text messaging it to a specified shared short code. The purchaser selects an available photo on her phone and sends it via a text message, which the purchaser's specific model of phone supports via MMS 29. The text message is subsequently received by the software, which determines that the text message is of the MMS variety and has an accompanying digital file that is waiting for download from the third party telephony-to-internet company that this particular implementation of the software employs for receiving MMS text messages 31. The software subsequently retrieves the digital photo and, since in this case the vendor has chosen to implement a minimal version of the present invention, simply emails the photo to an email address that the vendor has specified 32, along with an associated “confirmation number” that the software inserts into the email message.

Meanwhile, having received a valid MMS text message containing a digital photo from the purchaser, the software sends a return SMS message to the purchaser, thanking her for her submission, giving her the same “confirmation number” which it generated upon receipt of her photograph, and asking her to write it down on the order form in the space provided, next to the item number of the item on which she wants to print the photo that she just submitted 30. Following directions, the purchaser writes the confirmation number in the provided space on the order form 33, puts the order form and a check into the pre-paid envelope, and mails it to the vendor 34.

Several days later, the vendor receives the purchaser's order in the mail 35. Opening it, the vendor discovers the completed order form requesting one customized shirt, an accompanying confirmation number for the photograph that the purchaser sent via text message, and a check. The vendor logs into her Point of Sale system, rings up the order, and accepts the check. Then, having instructed the software to email any incoming photos to an email account created specifically for the purpose of fulfilling orders 32, the vendor signs into the email account and employs the email application's search functionality to search for the confirmation number that the purchaser included on the order form 36. Finding it in her email, the vendor downloads the photo and prepares it for printing on the t-shirt that the purchaser ordered 37.

### Third Embodiment

### Customized Mugs Ordered Online with Content Acquired from a Secondary Device

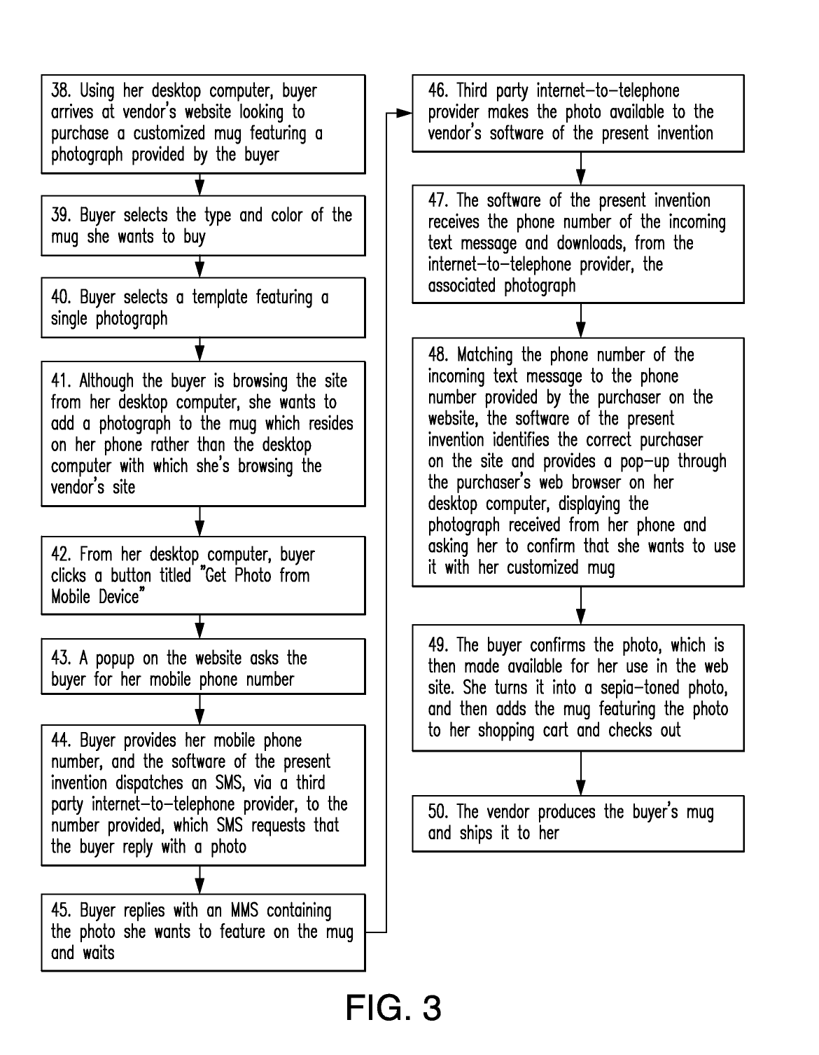

In the following example, illustrated in FIG. 3, a purchaser decides to order a customized mug featuring a photograph that she has taken. The purchaser, browsing the internet from her desktop computer, selects an online vendor who will produce and ship the customized mug to her 38.

This particular vendor provides an interface on its website which allows purchasers to customize products using their computer's web browser. As part of customizing her product, the purchaser selects the type of mug she wants (they come in several varieties), as well as specifying other options, such as the color of the mug 39. Additionally, the vendor offers “templates” from which the purchaser can choose, which templates feature a varying number of photos arranged in varying layouts, as well as allowing the purchaser to add captions and text. This particular vendor has programmed its website to make using such templates easy, such that the purchaser can simply select a template, then drag & drop in photos from her computer's file system, or click in the areas where text can be added and simply use the interface provided by the website to add any custom text she wants to add.

This particular purchaser selects a simple template for her mug—a single photo with no captions or text 40. Now, she simply needs to add a photo to the template to complete the customization of the mug. The purchaser is prompted by the website's interface to drag & drop a photo into the template.

At this point, however, the purchaser realizes that she doesn't have a mug-worthy photo available on her desktop computer because she now takes all of her pictures with her mobile phone 41. Instead of going through the laborious and tiresome process of transferring the photo from her phone to her computer (for instance, by emailing it to herself from the phone, opening the email on her computer and downloading the photo) and then uploading it through the interface provided on the website, the purchaser simply clicks a button on the website titled “Get Photo from Mobile Device” 42.

Subsequently, a popup appears on the website telling the purchaser that she can simply text message her photo from her phone and asks her for the phone number of her mobile device which contains the photograph she wants incorporated into the product in question 43. The purchaser provides her phone number, and the software of the present invention, hosted on the vendor's server, sends a text message to the device located at the phone number which the purchaser provided, asking her to reply with a text message containing a photo 44.

Since text messages are asychronous in nature, the buyer could choose to continue customizing the mug in other ways on her desktop computer (such as adding text if the mug had space for text which it does not) or even customize other products while also handling the text message exchange. Instead, the purchaser chooses to focus solely on getting her photo into the mug and so replies from her mobile device with a text message of the MMS variety, which contains a photo that she wants to feature on her customized mug, and simply waits 45. Since she is replying to a text message she has already received, the text message she sends is automatically sent back to the appropriate phone number, and the reply is sent to the internet-to-telephony provider employed by the vendor. The provider parses the purchaser's return MMS message, extracts the photo contained therein, and informs a software component located on the vendor's server that an incoming message has been received from the purchaser's telephone number and that a photo is available for download from the provider 46.

A component of the software of the present invention, executed on the vendor's server, then retrieves the photo from the URL specified in the message sent from the internet-to-telephony provider to the software component 47 and displays it in the website popup provided to the purchaser. The identity of the purchaser is known to the software of the present invention because she was initially asked for her phone number and an MMS containing a photo arrived from the same number she provided. The software then asks her to confirm that she would like to feature this photo on her mug 48.

Pleased with her selection, the purchaser affirms it, and the photo is then loaded into the template she has selected with respect to the customization of her mug 49. In an artistic mood, she then uses the customization options provided by the vendor's site to transform her colorful photo into a sepia-toned photo, adds the mug to her shopping cart and checks out 49. Several days later, her customized mug arrives in the mail 50.

### Fourth Embodiment

### Mug Customization Via an “App” with Content Acquired from a Secondary Device

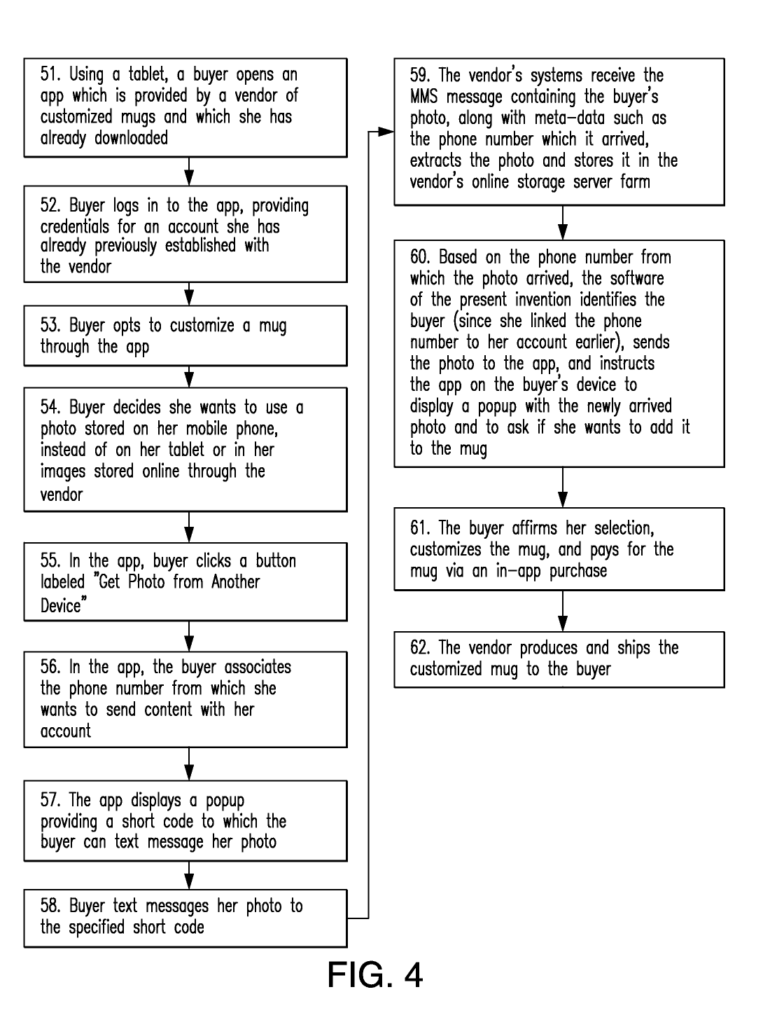

In the following example, illustrated in FIG. 4, the buyer of the third embodiment still wants to purchase a customized mug; however, instead of purchasing through the vendor's website, she decides to use an “app” from her tablet that the vendor has made available for the purpose of managing digital photo albums and making customized products from the photos contained in those albums 51.

In this particular example, the vendor has created an app that is installed on the tablet's local storage device and which allows the purchaser to view photos which are either stored on the device or on the vendor's servers (for instance, because the purchaser uploaded them to the vendor's servers, perhaps via another device).

The purchaser, wanting to purchase a customized mug, opens the app, logs in to an account she has previously created with the vendor 52, browses the customizable items that the vendor has for sale, selects a customized mug 53, and is prompted to select a photo which resides either on the tablet or on the vendor's servers. Browsing the photos that she's stored locally and with the vendor, the purchaser realizes that she'd rather use a photo she has on her mobile phone 54. The mobile phone, however, is produced by a different manufacturer than the purchaser's tablet, and uses a different operating system, for which the vendor of the customized mug does not produce a compatible application. The purchaser could go to her phone, open the phone's web browser, browse to the vendor's site, log in, upload the photo she wants, set down the phone, pick her tablet back up, and browse, via the application, the images stored in her account on the vendor's servers—but luckily, she can just click a button in the app titled “Get Photo from Another Device” 55.

The purchaser presses the button and a list of phone numbers for devices that the purchaser has already associated with her account appears, along with a button to add another device. As the phone from which she wants to text content does not appear in the list, the purchaser presses the button to add another device and types in the phone number of the phone from which she'll be sending her photo. Once she confirms the phone number, the app contacts software located on the vendor's servers to instruct it to associate the new phone number with the account which the purchaser logged in as when she started the app 56.

Then, the app displays a popup telling her she can text message her content to a specified short code 57. The purchaser picks up her mobile phone and text messages her photo to the specified short code 58.

In this case, the vendor has decided to use its own telephony equipment in its implementation of the present invention, and the telephony equipment receives the MMS sent by the user and informs the server that the message has arrived. The software of the present invention, located on the vendor's server, acquires the photo from the MMS and sends it to a server farm where the vendor stores all purchaser-provided content 59. Based on the phone number from which the text message containing the photo arrived, the software determines the purchaser's account (since the purchaser linked the phone number to the account) and sends the photo to the app on the purchaser's tablet (the identity of which the software knows because the purchaser logged in to the app on the tablet using her account information), along with instructions for the app to display the photo and ask the user to confirm that she wants to use it in her customized mug 60.

The app on the tablet displays a popup containing the photo which has been newly added to the purchaser's account and lets her proceed with the customization of her mug using it. The purchaser customizes the mug using the photo, and then pays for her order directly in the app via an in-app purchase 61, after which the vendor then produces and ships the mug to her 62. The photo which the purchaser text messaged remains on the vendor's servers and is displayed in future use of the app so that the purchaser can choose to customize other products using the same photo.

### Fifth Embodiment

### Yearbook Photos Through an Intermediary Service

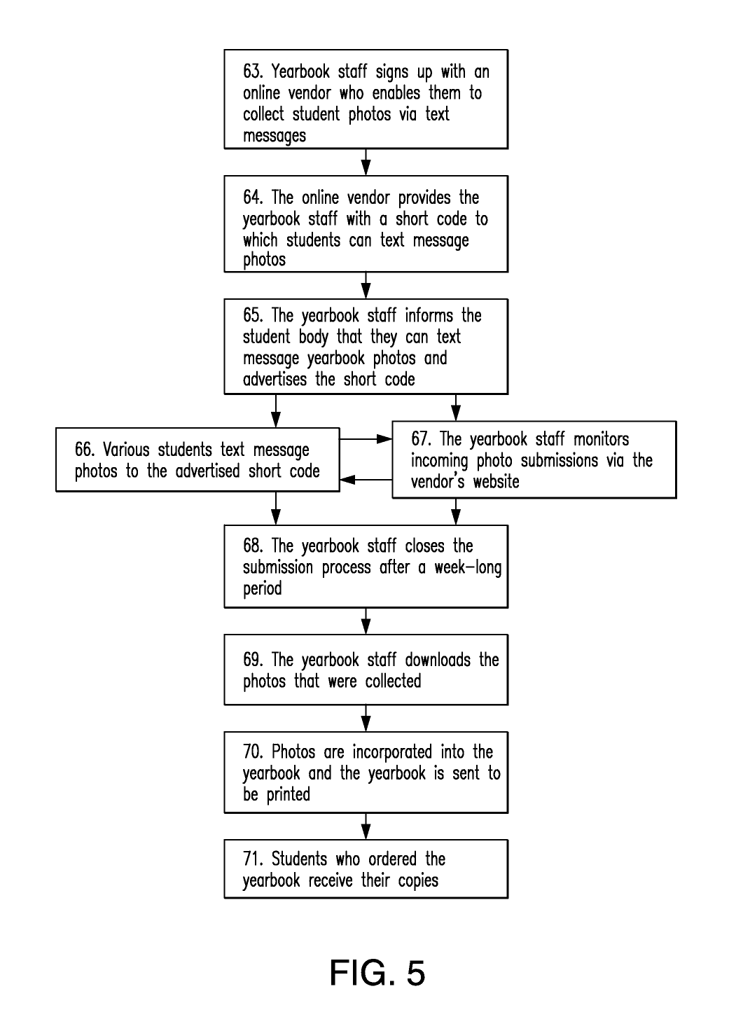

In the following example, illustrated in FIG. 5, a school has decided that it wants to feature photos in its yearbook taken by students who attend the school. Without the software of the present invention, such an undertaking would entail requesting that students email photos or provide hard copies of photographs which are then scanned in to digitize them. Even with email, categorizing and tracking the incoming photos would be an arduous task. With the software of the present invention, the yearbook staff simply provides a short code to which students can text message photos from their mobile phones, and the incoming photos are provided to the yearbook staff in an easy-to-view gallery which offers a one-click download of all of the submitted photos 64, 65, 67. As implementing the software of the present invention to accomplish such a task would be a time-consuming task, the yearbook staff signs up online with a vendor who offers to handle collecting the photos from students via text message 63. After they sign up, yearbook staff members can sign in to their account with this vendor, view the photos which have been submitted, and download all of the photos with a single click 67, 69.

For a week, the staff members of the yearbook invite students to text message photos to the specified short code 65, regardless of whether they intend to purchase a yearbook. Consequently, any student who text messages a photo contributes content to the yearbook without necessarily purchasing it. After a week has passed, the yearbook staff instructs the software of the present invention, hosted by the third-party vendor, to stop accepting new submissions 68, and they then download the collected photos from the vendor 69.

The yearbook staff then incorporates the collected photos into their yearbook and sends the yearbook to a different vendor to be printed 70. Students who decided to purchase a yearbook are provided with the customized product 71.

### Sixth Embodiment

### Online Photography Marketplace

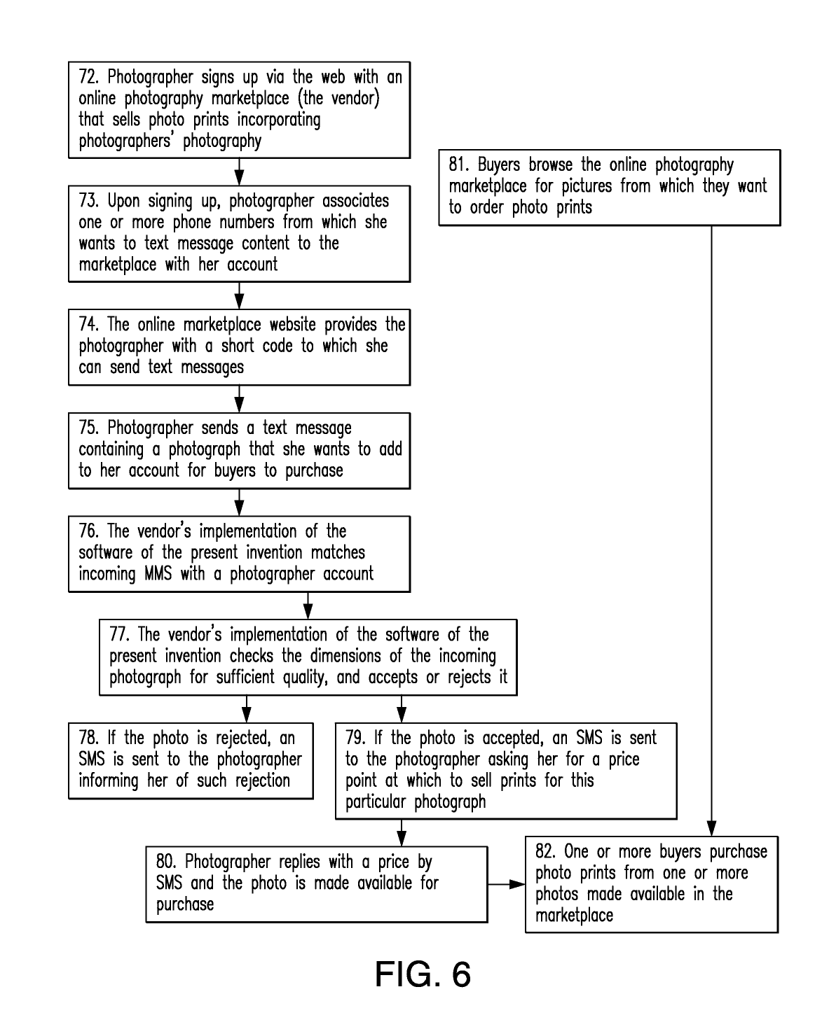

In the following example, illustrated in FIG. 6, a vendor has created an online photography marketplace in which photographers can post photographs which buyers may purchase in the form of photo prints manufactured by the vendor. The vendor keeps a portion of the revenue of the sale, and the photographer receives a portion, since the prints manufactured by the vendor feature his/her photography. Photographers can add photos to their accounts on the vendor's site by visiting the vendor's site, logging in, uploading photos in a traditional manner, and setting prices. However, to facilitate collection of content for the marketplace, the vendor has also implemented the present invention so that photographers possessing mobile, text-message-enabled devices with built-in cameras of sufficient quality can contribute content to the marketplace via text message, since more recently-manufactured mobile devices now contain integrated cameras which produce photographs of sufficient quality for the vendor to produce photo prints from the resulting pictures.

Upon signing up online at the vendor's website 72, photographers provide one or more phone numbers from which they want to be able to text message content to the vendor, which phone numbers are then associated with their accounts 73. In exchange, the vendor provides each photographer with a short code to which she can send text messages containing photographs 74.

Accordingly, when a photographer takes a picture with a text-message-enabled mobile device and wants to add to the marketplace website a photograph which buyers can purchase as photo prints, she simply sends it via text message to the short code which the vendor provided 75. Once the MMS is received by the vendor's systems, the vendor's system identifies the photographer who is sending it 76 by matching the phone number of the incoming MMS to the list of phone numbers on the photographers' accounts. Then two actions are taken: first, the software automatically checks the dimensions of the photograph to ensure that the photograph has a high enough resolution to provide a photo print of sufficient quality 77 (since mobile devices featuring less advanced cameras are still in circulation) and either accepts or rejects the photo; and second, if the photo is rejected, the system sends a reply SMS informing the photographer of such 78, and if the photo is accepted, then it sends a reply SMS to the photographer asking for the price at which the photographer wants to sell prints of this particular photograph 79.

Once the photographer's photo has been accepted and a price set via a return reply sent via text message by the photographer, the photo is added to the vendor's collection of photographs made available for purchase as photo prints 80, and the product is then displayed to potential purchasers who visit the marketplace site. Buyers may then arrive at the site through a web browser, view the photographs made available for purchase 81, and purchase one or more photographs in the form of photo prints which the vendor will produce and ship to the buyer 82. Although the foregoing embodiments of the present invention have been disclosed for illustrative purposes, those skilled in the art will appreciate that many additions, modifications and substitutions are possible, without departing from the scope and spirit of the present invention, as defined by the accompanying claims.

What is claimed is:

1. A method for customizing the content of a product or service, the method comprising the following steps:
providing one or more software components, which are executed on or made available from one or more servers, computer systems, or devices, or are available as a remotely accessible service, wherein the software components enable one or more content contributors and/or one or more purchasers to submit, select or identify, via one or more text messages sent from one or more text-message-enabled computers, servers or devices, customization content to be incorporated into the product or service;
initiating an exchange of one or more text messages between the software components and one or more purchasers and/or content contributors, in which exchange the purchasers and/or content contributors submit, select or identify the customization content to be incorporated into the product or service;
using the software components to make the customization content available to or identifiable by one or more vendors for incorporation into the product or service;
producing, or making available for purchase, a customized product or a customized service which incorporates or will incorporate the customization content either in an unmodified form or in a modified or derivative form; and
providing to the purchasers, or to the content contributors, or to both the purchasers and the content contributors, the customized product or the customized service incorporating the customization content.

2. The method of claim 1, further comprising the following additional steps:
prior to providing the customized product or customized service, initiating an exchange of one or more text messages between the software components and the vendors, in which exchange the vendors submit content, customization content, descriptive data, images or simulations concerning the customized product or the customized service; and
using the software components to make the submitted content, customization content, descriptive data, images or simulations available to the purchasers, or to the content contributors, or to both the purchasers and the content contributors for review.

3. The method of claim 1, further comprising the following additional steps:
prior to providing the customized product or customized service, using the software components to generate or acquire one or more preview images or simulations of the customized product or customized service; and
using the software components to make the preview images or simulations available to the purchasers, or to the content contributors, or both the purchasers and the content contributors for review.

4. The method of claim 1, wherein the software components are utilized to direct or control production of the customized product or the customized service and to incorporate the customization content therein.

5. The method of claim 2, wherein the software components are utilized to direct or control production of the customized product or the customized service and to incorporate the customization content therein.

6. The method of claim 3, wherein the software components are utilized to direct or control production of the customized product or the customized service and to incorporate the customization content therein.

7. The method of claim 1, further comprising the following additional step:
Prior to producing or making available for purchase a customized product or a customized service, providing to the purchasers, or to the content contributors, or to both the purchasers and the content contributors the product or service in a condition in which it is not yet customized, or in which one or more non-customized components of the product or service are replaceable with customized components;

8. The method of claim 7, wherein the software components are utilized to direct or control production of the customized product or the customized service and to incorporate the customization content therein.

9. The method of claim 1, wherein the software components also enable the purchasers or the content contributors, or both the purchasers and the content contributors to submit, select or identify, via one or more text messages sent from one or more text-message-enabled computers, servers or devices, customization content to be stored on one or more websites, vendor websites, servers, devices or systems, from which submitted customization content the purchasers, or the content contributors, or both the purchasers and the content contributors subsequently select or identify customization content to be incorporated into the product or service.

10. The method of claim 9, wherein the software components are utilized to direct or control production of the customized product or the customized service and to incorporate the customization content therein.

11. The method of any one of claims 1-10, wherein the exchange of text messages between the software components and the purchasers, or between the software components and the content contributors, or between the software components and both the purchasers and the content contributors are viewed by one or more agents of the vendor and concurrently or alternatively monitored by the software components in order to determine the sufficiency of the submitted customization content or to seek clarification thereof.

12. The method of any one of claims 1-10, wherein the purchasers, or the content contributors, or both the purchasers and the content contributors use one or more primary devices to customize the product or service by interaction of the primary devices with one or more vendor websites, on which some or all of the software components are executed, and wherein the software components enable the purchasers, or the content contributors, or both the purchasers and the content contributors to use one or more secondary devices to submit, via one or more text messages, all or part of the customization content to the vendor or to the vendor websites.

13. The method of claim 12, wherein some of the software components are executed on the primary devices, or on the secondary devices, or on both the primary devices and the secondary devices.

14. The method of any one of claims 1-10, wherein the purchasers, or the content contributors, or both the purchasers and the content contributors use one or more primary devices to customize the product or service by interaction of the primary devices with one or more vendor websites, and wherein the software components enable the purchasers, or the content contributors, or both the purchasers and the content contributors to use one or more secondary devices to submit, via one or more text messages, all or part of the customization content to the vendor or to the vendor website, and wherein all of the software components are executed on the primary devices or on the primary devices and the secondary devices.

15. The method of claim 11, wherein the purchasers, or the content contributors, or both the purchasers and the content contributors use one or more primary devices to customize the product or service by interaction of the primary devices with one or more vendor websites, on which some or all of the software components are executed, and wherein the software components enable the purchasers, or the content contributors, or both the purchasers and the content contributors to use one or more secondary devices to submit, via one or more text messages, all or part of the customization content to the vendor or to the vendor websites.

16. The method of claim 11, wherein some of the software components are executed on the primary devices, or on the secondary devices, or on both the primary devices and the secondary devices.

17. The method of claim 11, wherein the purchasers, or the content contributors, or both the purchasers and the content contributors use one or more primary devices to customize the product or service by interaction of the primary devices with one or more vendor websites, and wherein the software components enable the purchasers, or the content contributors, or both the purchasers and the content contributors to use one or more secondary devices to submit, via one or more text messages, all or part of the customization content to the vendor or to the vendor website, and wherein all of the software components are executed on the primary devices or on the primary devices and the secondary devices.
